(19) United States
(12) Patent Application Publication
(10) Pub. No.: US 2019/0114645 A1
(43) Pub. Date: Apr. 18, 2019

(54) SYSTEM AND METHODS FOR IMPROVED PAYMENT ACCOUNT TRANSACTION PROCESS

(71) Applicant: MasterCard International Incorporated, Purchase, NY (US)

(72) Inventors: John Gaitanos, London (GB); Alan Johnson, Salcott, Maldon (GB)

(21) Appl. No.: 15/786,956

(22) Filed: Oct. 18, 2017

(51) Int. Cl. G06Q 20/42; G06Q 20/20; G06Q 20/32; G06Q 20/36; G06Q 20/40; H04W 4/00

(52) U.S. Cl. CPC G06Q 20/425; G06Q 20/204; G06Q 20/3223; H04W 4/008; G06Q 20/3674; G06Q 20/4012; G06Q 20/40145; G06Q 20/327

(57) ABSTRACT

A payment-enabled mobile device is employed to initiate a transaction at a payment terminal. The payment-enabled mobile device is in communication with the payment terminal via a first communication channel. An indication is received via the payment terminal that the transaction is declined. The indication is displayed on a display component of the payment terminal. A decline reason message is displayed on the payment-enabled mobile device. The decline reason message presents information received by the payment-enabled mobile device via a second communication channel that is different from the first communication channel.

### BACKGROUND

FIG. 1 is a block diagram that illustrates a conventional payment system 100.

The system 100 includes a payment device 102 (which may in some situations be a payment-enabled mobile device that stores a payment card account number and runs a payment applet; other form factors for the payment device, such as a fob, are also possible; also card-shaped payment devices, including payment IC cards and magnetic stripe cards are widely used). The system 100 further includes a reader component 104 associated with a POS (point of sale) terminal 106. In some known manner the reader component 104 is capable of reading the payment card account number and other information from the payment device 102. (Some usages include the term “point of interaction” to include both the point of sale at a retail store, plus card acceptance terminals or the like at premises of service providers, transit system entrance gate terminals, etc.)

The reader component 104 and the POS terminal 106 may be located at the premises of a retail store and operated by a sales associate of the retailer for the purpose of processing retail transactions. The payment device 102 is shown in FIG. 1 to be interacting with the reader component 104 and the POS terminal 106 for the purpose of executing such a transaction.

A computer 108 operated by an acquirer (acquiring financial institution) is also shown as part of the system 100 in FIG. 1. The acquirer computer 108 may operate to receive an authorization request for the transaction from the POS terminal 106. The acquirer computer 108 may route the authorization request via a payment network 110 (sometimes also referred to as a “card network”) to the server computer 112 operated by the issuer of a payment account that is associated with the payment device 102. An authorization response generated by the payment account issuer server computer 112 may be routed back to the POS terminal 106 via the payment network 110 and the acquirer computer 108.

One well known example of a payment network is referred to as the “Banknet” system, and is operated by Mastercard International Incorporated, which is the assignee hereof.

The payment account issuer server computer 112 may be operated by or on behalf of a financial institution (“FI”) that issues payment accounts to individual users and/or other entities. For example, the payment account issuer server computer 112 may perform such functions as (a) receiving and responding to requests for authorization of payment account transactions to be charged to payment accounts issued by the FI; and (b) tracking and storing transactions and maintaining account records.

The components of the system 100 as depicted in FIG. 1 are only those that are needed for processing a single transaction. A typical payment system may process many purchase transactions (including simultaneous transactions) and may include a considerable number of payment account issuers and their computers, a considerable number of acquirers and their computers, and numerous merchants and their POS terminals and associated reader components. The system may also include a very large number of payment account holders, who carry payment devices for initiating payment transactions by presenting an associated payment account number to the reader component of a POS terminal.

A typical payment system like that shown in FIG. 1 may also handle other types of transactions, including online shopping transactions in which the purchaser submits a payment account number and related data to an e-commerce website-hosting computer.

Referring again to the authorization response mentioned above, which is generated by the account issuer and routed to the point of sale, the indication provided in such authorization response may indicate that the requested transaction is approved, but alternatively, in some cases, the authorization response may indicate that the requested transaction is declined.

The present inventors have now recognized opportunities to improve handling of situations in which the authorization response indicates the requested transaction is declined.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a conventional payment system.

FIG. 2 is a block diagram that illustrates a payment system provided according to aspects of the present disclosure.

FIG. 3 is a simplified block diagram of a payment-enabled mobile device that may be operated in the payment system of FIG. 2.

FIG. 4 is a block diagram that illustrates a point of interaction (POI) terminal that may perform a role in the payment system of FIG. 2.

FIG. 5 is a block diagram that illustrates a computer system that may perform a role in the payment system of FIG. 2.

FIG. 6 is a flow chart that illustrates a process that may be performed in the payment system of FIG. 2 according to aspects of the present disclosure.

### DETAILED DESCRIPTION

In general, and for the purpose of introducing concepts of embodiments of the present invention, a payment system may handle declined payment account transactions in a manner that is more user-friendly than in conventional payment systems. When an authorization response indicates that a transaction is declined, the payment network may provide additional messaging, in parallel with the authorization response, such that an account holder's payment-enabled mobile device at the point of sale may receive and display additional information related to the declined transaction. The additional information may indicate a reason or reasons why the transaction was declined and/or may prompt the account holder to take one or more actions to facilitate a successful retry of the declined transaction.

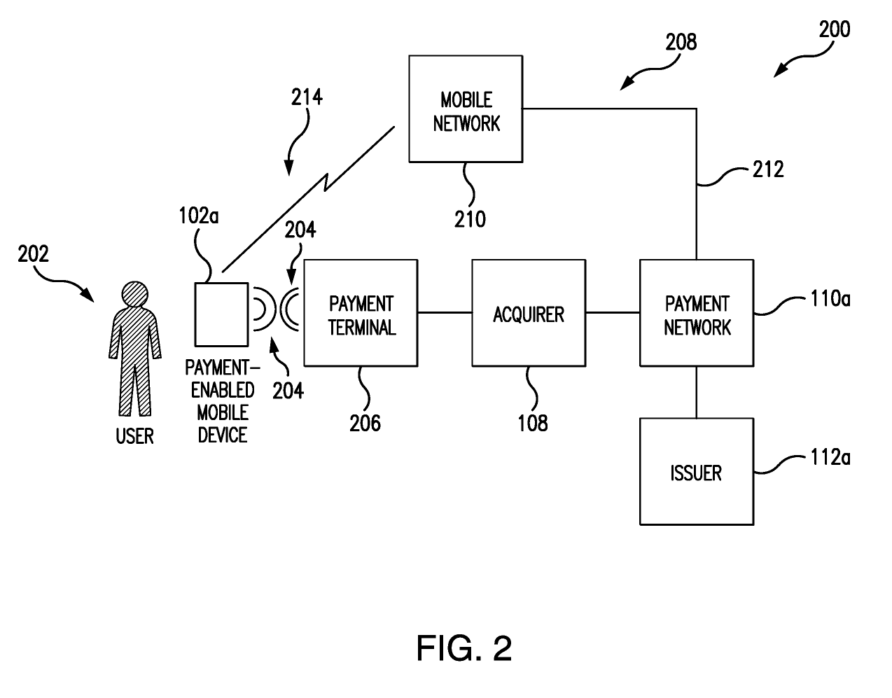

FIG. 2 is a block diagram that illustrates a payment system 200 provided according to aspects of the present disclosure.

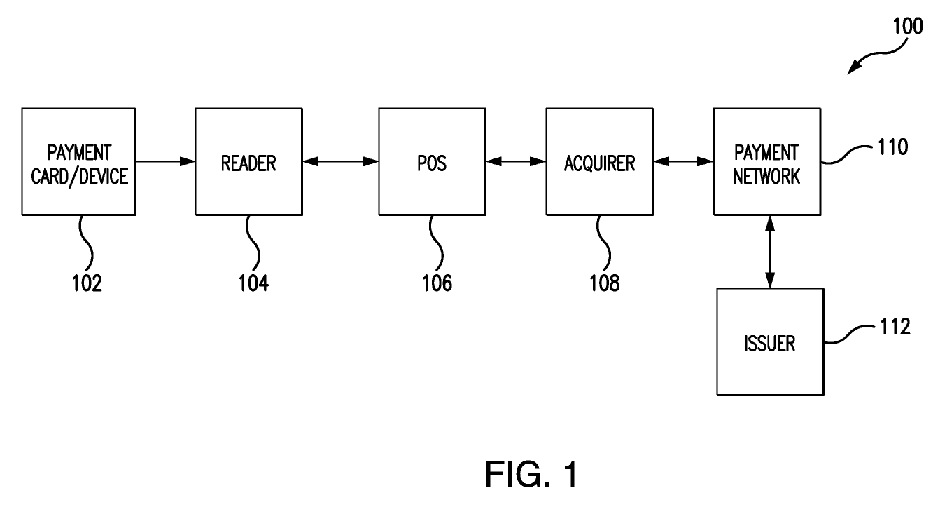

In addition to and/or inclusive of components shown in FIG. 2, the payment system 200 may include all elements of the payment system 100 of FIG. 1 as mentioned above in connection with FIG. 1.

As seen in FIG. 2, a user/account holder 202 presents his/her payment-enabled mobile device 102a at a point of sale to interact (via short range-radio communication 204) with a payment terminal 206 for the purpose of initiating a payment transaction. The payment terminal 206 may encompass the reader 104 and the POS 106 shown in FIG. 1 and may operate in a manner typically seen in payment account transactions. As before, the payment system 200 may further include an acquirer 108. Still further, the payment system 200 may include a payment network (reference numeral 110a) having both typical transaction routing capabilities and enhanced capabilities (as described below) in accordance with aspects of the present disclosure. Also shown is the account issuer 112a which had previously provisioned or caused to be provisioned a digitized payment account number to the payment-enabled mobile device 102a shown in FIG. 2. In accordance with aspects of the present disclosure, there is a channel of communication 208 from the payment network 110a to the payment-enabled mobile device 102a. The channel of communication 208 may include a mobile telecommunications network 210 with which the payment-enabled mobile device 102a is registered for typical voice and/or data mobile communications. The payment network 110a communicates 212 with the mobile communication network 210 to allow for over-the-air messaging 214 from the payment network 110a to the payment-enabled mobile device 102a. As will be seen, the channel of communication 208 may be utilized by the payment network 110a to send supplemental information to the payment-enabled mobile device 102a in connection with transactions requested via the payment-enabled mobile device 102a but declined by the account issuer 112a.

(The short-range radio communication indicated at 204 in FIG. 2 may be considered a separate and different communication channel from the channel of communications 208.)

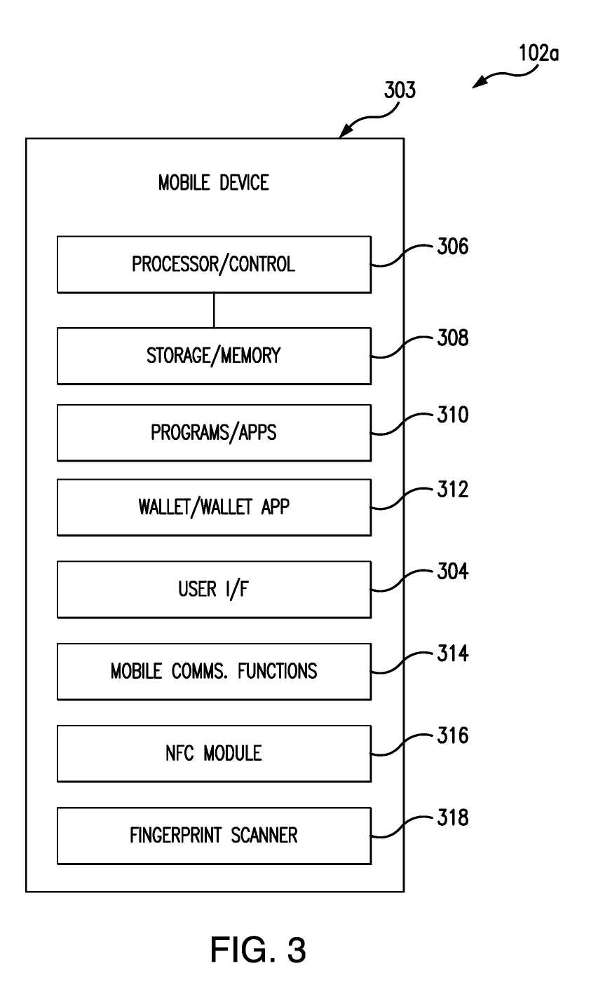

FIG. 3 is a simplified block diagram illustration of a typical embodiment of the payment-enabled mobile device 102a shown in FIG. 2.

To some extent, it will be posited in the following discussion, without limitation, that the payment-enabled mobile device 102a is a smartphone.

The payment-enabled mobile device 102a may include a housing 303. In many embodiments, the front of the housing 303 is predominantly constituted by a touchscreen (not separately shown), which is a key element of the user interface 304 of the payment-enabled mobile device 102a.

The payment-enabled mobile device 102a further includes a mobile processor/control circuit 306, which is contained within the housing 303. Also included in the payment-enabled mobile device 102a is a storage/memory device or devices (reference numeral 308). The storage/memory devices 308 are in communication with the processor/control circuit 306 and may contain program instructions to control the processor/control circuit 306 to manage and perform various functions of the payment-enabled mobile device 102a. As is well-known, a smartphone may function as what is in effect a pocket-sized personal computer, via programming with a number of application programs, or “apps”, as well as a mobile operating system (OS). (The apps are represented at block 310 in FIG. 3, and may, along with other programs, in practice be stored in block 308, to program the processor/control circuit 306.) In view of the pertinence of digital wallets to the teachings of this disclosure, a digital wallet/wallet app is shown separately from the apps 310 and is represented by block 312. In many respects the wallet app 312 may be similar to wallet apps that have been proposed for payment-enabled mobile phones. In some embodiments, the wallet app 312 may be employed to access a remotely maintained digital wallet for the user 202. The wallet app 312 may also play a role, as described below, in providing supplemental information regarding declined transactions to the user 202 (FIG. 2).

As is typical for smartphones, the payment-enabled mobile device 102a may include mobile communications functions as represented by block 314 (FIG. 3). The mobile communications functions may include voice and data communications via the mobile network 210 (FIG. 2), whereby over-the-air messages may be received by the wallet app 312 from the payment network 110a. The wallet app 312 may have been provisioned to the payment-enabled mobile device 102a from the payment network 110a or by a service entity affiliated with the payment network 110a.

Moreover, the payment-enabled mobile device 102a may further include hardware and software/firmware to implement NFC (near field communication) capabilities or the like (represented by block 316 in the drawing) to facilitate interactions/short range-data communication between the payment-enabled mobile device 102a and the payment terminal 206 (FIG. 2). Thus the NFC capabilities 316 support the payment-related functionality of the payment-enabled mobile device 102a.

According to the example embodiment of FIG. 3, the payment-enabled mobile device 102a also includes a fingerprint scanning module 318 such as is now included in some mobile devices to support biometric user authentication in connection with payment transactions or for other purposes. As in some known or proposed mobile devices, the fingerprint scanning module 318 may be an access point to allow the user 202 to access the wallet/wallet app 312.

From the foregoing discussion, it will be appreciated that the blocks depicted in FIG. 3 as components of the payment-enabled mobile device 102a may in effect overlap with each other, and/or there may be functional connections among the blocks which are not explicitly shown in the drawing. It may also be assumed that, like a typical smartphone, the payment-enabled mobile device 102a may include a rechargeable battery (not shown) that is contained within the housing 303 and that provides electrical power to the active components of the payment-enabled mobile device 102a.

Although the payment-enabled mobile device 102a has been described herein primarily as a smartphone, other types of mobile devices (e.g., a tablet computer) may be used in place of a smartphone in other embodiments.

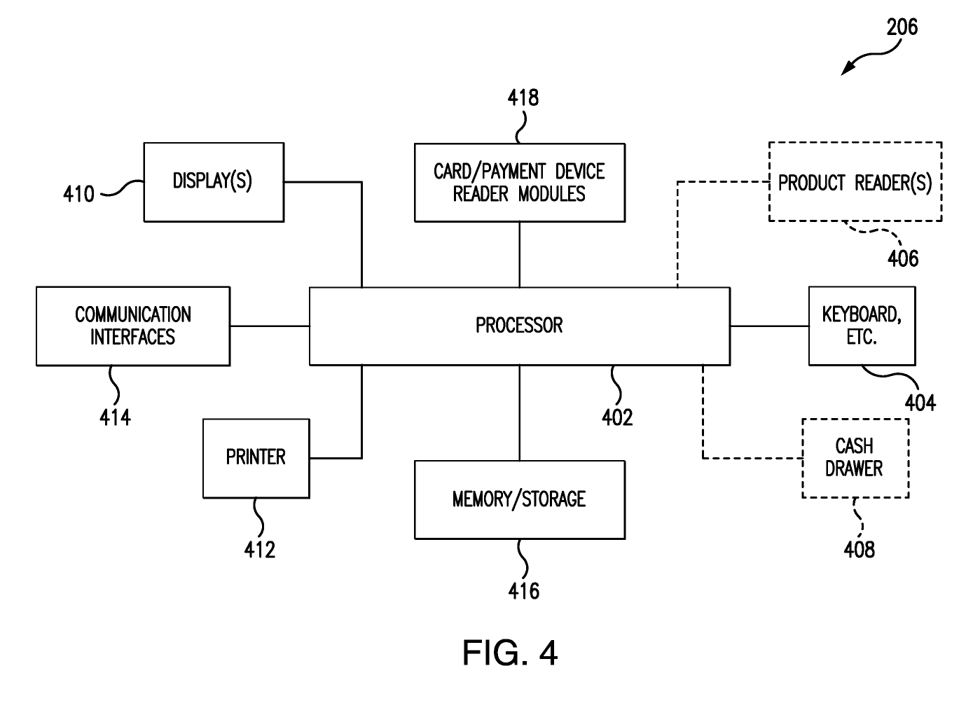

FIG. 4 is a block diagram that illustrates an embodiment of the payment terminal 206 shown in FIG. 2. In some respects, the payment terminal 206 may resemble a typical POS terminal such as typically seen at the checkout counter in a retail store. In other embodiments, the hardware making up the payment terminal 206 may be a suitably programmed personal computer, laptop computer or tablet computer, with an associated device-reading peripheral or peripherals. The payment terminal 206 need not necessarily depart from the customary functioning of such terminals.

Referring now to FIG. 4, the payment terminal 206 may include a processing element (or elements) such as the processor 402 shown in FIG. 4. The processor 402 may, for example, be a commercially available microprocessor, and may operate to control the overall functioning of the payment terminal 206.

The payment terminal 206 may also include peripheral components, in communication with and/or controlled by the processor 402, such as: (a) a keyboard 404 for receiving input from the human operator of the payment terminal 206, together with other input devices (not separately shown, such as a numeric keypad, a mouse, and/or a touch screen); (b) a product reader 406 (shown in phantom, for some embodiments) for reading any form of unique product identifier, such as a barcode or RFID, that appears on, or is attached to, products brought to the payment terminal 206 for purchase; (c) a cash drawer 408 (shown in phantom, for some embodiments) for storing cash received from customers; (d) one or more displays 410 for providing output and/or (in some embodiments) identifying products presented for purchase and their prices, indicating sales tax due, indicating transaction subtotals and totals, etc., providing prompts to the customer and/or to the service provider)—and, most pertinently for present purposes, displaying messages to indicate that requested payment account transactions have been approved or declined according to transaction authorization response messages routed from account issuers to the payment terminal 206; (e) a printer 412 for printing out documents and/or sales receipts; and (f) a number of communication interfaces 414 for allowing the processor 402, and hence, the payment terminal 206 to engage in communication over data networks with other devices (e.g., the acquirer 108 and one or more other devices).

In addition, the payment terminal 206 may include one or more memory and/or data storage devices (indicated collectively at 416), which may comprise any combination of one or more of a hard disk drive, RAM (random access memory), ROM (read only memory), flash memory, etc. The memory/data storage device(s) 416 may store software and/or firmware that programs the processor 402 and the payment terminal 206 to perform its functionality in what may be a conventional manner. Thus the memory/data storage device(s) 416 may be in communication with the processor 402. Further, the payment terminal 206 may include one or more housings (not shown) which contain and/or support one or more of the other components shown in FIG. 4.

Further, the payment terminal 206 may include one or more card/payment device-reader elements (block 418) such as a mag stripe reader, a contact IC card reader, a contactless IC card reader, NFC communications capabilities (for communicating with payment-enabled mobile devices), etc. The reader elements 418 may be in communication with the processor 402.

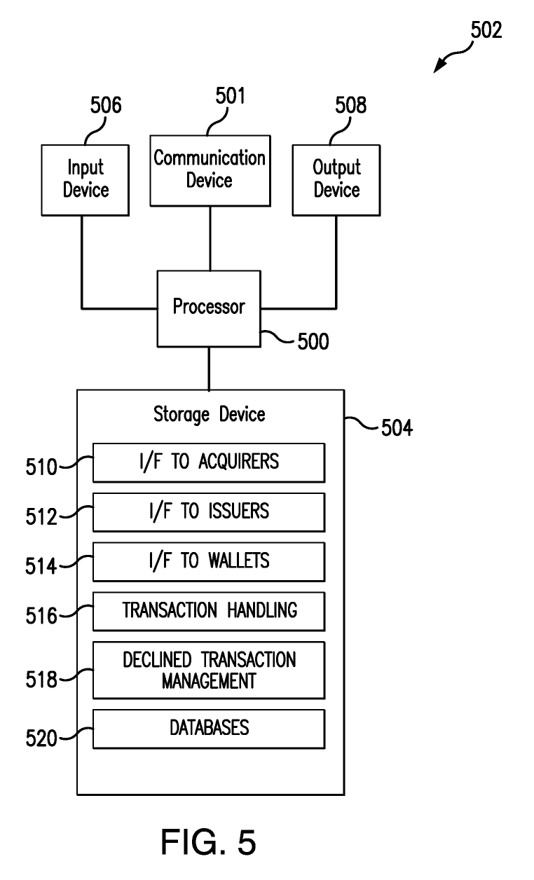

FIG. 5 is a block diagram that illustrates a computer system 502 that may implement and perform at least some of the functionality of the payment network 110a. Accordingly, the computer system 502 may hereinafter be referred to as the payment network computer 502.

Referring now to FIG. 5, the payment network computer 502 may, in its hardware aspects, resemble a typical server computer and/or mainframe computer, but may be controlled by software to cause it to function as described herein. For example, the payment network computer 502 may be constituted by commercially available server computer hardware and/or by cloud-based computing resources.

The payment network computer 502 may include a computer processor 500 operatively coupled to a communication device 501, a storage device 504, an input device 506 and an output device 508. The communications device 501, the storage device 504, the input device 506 and the output device 508 may all be in communication with the processor 500.

The computer processor 500 may be constituted by one or more conventional processors. Processor 500 operates to execute processor-executable steps, contained in program instructions described below, so as to control the payment network computer 502 to provide desired functionality.

Communication device 501 may be used to facilitate communication with, for example, other devices (such as computers operated by acquirers and account issuers and with numerous payment-enabled mobile devices, for purposes as described in this disclosure). For example (and continuing to refer to FIG. 5), communication device 501 may comprise numerous communication ports (not separately shown), to allow the payment network computer 502 to communicate simultaneously with a number of other computers and other devices, including communications as required to simultaneously handle numerous payment transactions.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the payment network computer 502, executed by the processor 500 to cause the payment network computer 502 to function as described herein.

The programs may include one or more conventional operating systems (not shown) that control the processor 500 so as to manage and coordinate activities and sharing of resources in the payment network computer 502, and to serve as a host for application programs (described below) that run on the payment network computer 502.

The programs stored in the storage device 504 may also include a communications software interface 510 to support communications between the payment network computer 502 and computers operated by or on behalf of transaction acquirers.

The storage device 504 may also store a communications software interface 512 to support communications between the payment network computer 502 and computers operated by or on behalf of payment account issuers.

Still further, the storage device 504 may store a communications software interface 514 to facilitate messaging from the payment network computer 502 to the respective wallet apps in numerous payment-enabled mobile devices such as the device 102a shown in FIGS. 2 and 3.

Continuing to refer to FIG. 5, the storage device 504 may also store a transaction handling application program 516 which may provide customary functionality for routing transaction authorization request messages and transaction authorization response messages and other functions normally performed with respect to payment account transactions at the locus of a transaction network.

Moreover, the storage device 504 may additionally store an application program 518 for managing generation and dispatching of additional/supplemental information messages to payment-enabled mobile devices in connection with current transactions that the account issuer has declined.

The storage device 504 may also store, and the payment network computer 502 may also execute, other programs, which are not shown. For example, such programs may include a reporting application, which may respond to requests from system administrators for reports on the activities performed by the payment network computer 502. The other programs may also include, e.g., a database management program, device drivers, etc.

The storage device 504 may also store one or more databases 520 required for operation of the payment network computer 502.

A process that may be performed in the payment system 200 of FIG. 2 will now be described.

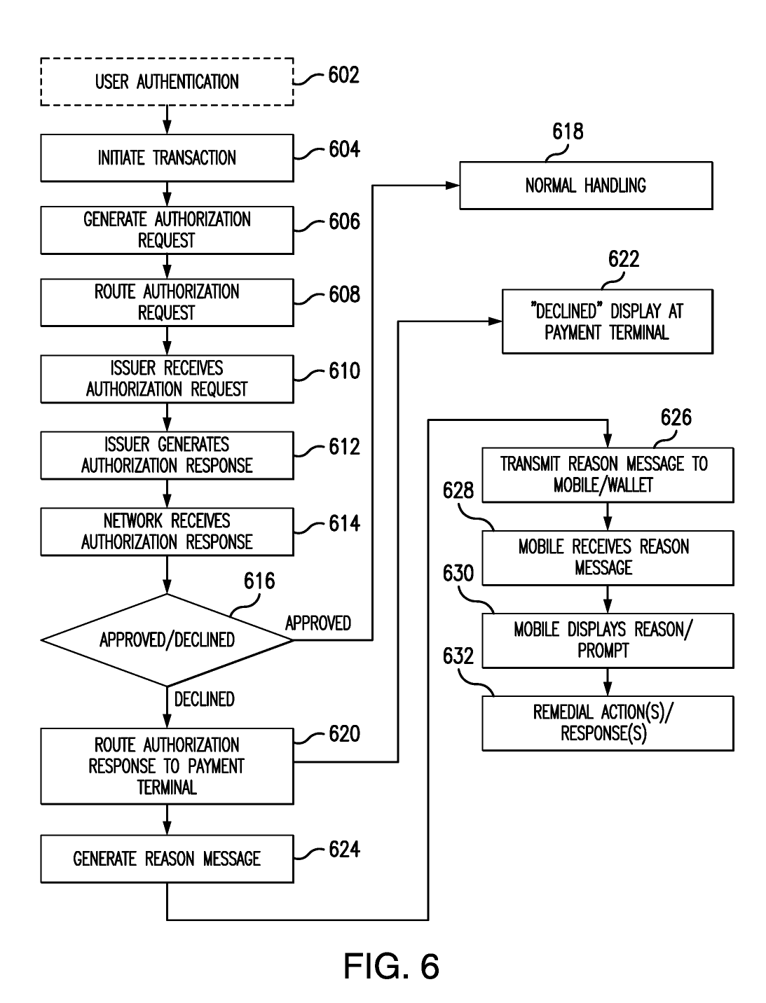

As indicated in phantom at 602 in FIG. 6, shortly in advance of a payment transaction, a user authentication process may occur whereby the user 202 authenticates himself/herself to the payment-enabled mobile device 102a. This may allow the user 202 to gain access to the wallet/wallet app 312 (FIG. 3) in the payment-enabled mobile device 102a. In some embodiments, and/or in some situations, this may involve a biometric user authentication process, such as a fingerprint/thumbprint scan; one possible manner of user authentication would be entry of a wallet PIN (personal identification number), or a password or the like.

It will be appreciated that, in some contexts, the process of block 602 (or the process of block 604, as described below) may occur at the checkout counter of a retail store. The user 202 may have brought items (not shown) to be purchased to the checkout counter, and the payment terminal 206 may have scanned tags on the items to identify the items and permit the charge for the transaction (e.g., including sales tax) to be calculated by the payment terminal 206.

At block 604, the payment account transaction may be initiated by the user 202 tapping his/her payment-enabled mobile device 102a at a suitable location on the payment terminal 206 to allow the payment-enabled mobile device 102a to be read by the payment terminal 206. As is customary, an exchange of data messages may occur between the payment terminal 206 and the payment-enabled mobile device 102a via NFC or the like. For example, the data exchange may include the payment-enabled mobile device 102a transmitting a user-selected payment account number or token (representing one of the user's payment accounts) to the payment terminal 206. Other related information may also be transmitted from the payment-enabled mobile device 102a to the payment terminal 206. Such information may include an indication as to whether the user has recently (e.g., upon accessing the wallet app/wallet 312 immediately before the transaction) authenticated himself/herself to the wallet app/wallet 312, and if so, in what manner (e.g., biometrically or via PIN entry).

At block 606 the payment terminal 206 may generate a transaction authorization request message (also referred to as an “authorization request”). This may be done in a customary manner as currently takes place in payment account systems. The authorization request may include the transaction amount, a payment account number or token (received by the payment terminal 206 from the payment-enabled mobile device 102a at 604), and other information typically included in an authorization request. In some situations, the authorization request may contain data codes to indicate whether and/or how user authentication was performed with respect to the current transaction.

At block 608, the authorization request may be routed from the payment terminal 206 through the payment system 200. This also may occur in a manner as customarily performed in payment account systems. For example, the authorization request may be routed from the payment terminal 206 to a transaction processor (not shown apart from the acquirer 108) and/or to the acquirer 108. In some situations or arrangements, the authorization request may be forwarded from the payment terminal 206 to the transaction processor/acquirer via a merchant system (not shown). From the acquirer 108 and/or the transaction processor, the authorization request may be routed to the payment network 110a, and from the payment network 110a to the account issuer 112a. If the authorization request contains a payment token, detokenization (i.e., translation to a payment account number) may occur by or in association with the payment network 110a.

At block 610, the account issuer 112a receives the authorization request via the payment network 110a. At block 612, the account issuer generates a transaction authorization response message (also referred to as an “authorization response”) by processing the authorization request. This may occur in a generally or entirely customary manner in accordance with current practices in payment account systems. However, as will be seen, in some situations or in some embodiments, the authorization response may include data that is different from or in addition to data currently included in a typical authorization response. It will be appreciated that the authorization response may indicate that the transaction is approved or the authorization response may indicate that the transaction is declined. Examples of situations in which the transaction may be declined will be discussed further below. If the transaction is declined, the authorization response as generated by the account issuer 112a may contain a data code that indicates a reason why the transaction was declined. After the authorization response is generated, it is routed to the payment network 110a from the account issuer 112a.

At block 614, the payment network 110a receives the authorization response from the account issuer 112a.

A decision block 616 may follow block 614 in the process of FIG. 6. At decision block 616, the payment network 110a (e.g., via the payment network computer 502) may determine whether (according to the authorization response received at 614) the transaction has been approved or declined. If the payment network 110a detects at 616 that the transaction has been approved, then the process of FIG. 6 may branch from decision block 616 to block 618. At block 618, the balance of the processing of the transaction, including routing of the authorization response to the payment terminal 206, may proceed in a conventional manner for handling approved payment account system transactions.

If the payment network 110a detects at 616 that the transaction has been declined, then the process of FIG. 6 may branch from decision block 616 to block 620. At block 620, the payment network 110a may route the authorization request message to the payment terminal 206, leading to block 622. At block 622, the payment terminal 206 may display a conventional message such as “transaction declined” on a display component or components 410 (FIG. 4) of the payment terminal 206.

Continuing to refer to FIG. 6, and further to the branching of the process to block 620, block 624 may also be performed. At block 624, the payment network 110a (e.g., via payment network computer 502) may generate a “decline reason” message according to teachings of this present disclosure. By “decline reason” message is meant a message that contains information supplemental to and/or different from the message displayed at 622 by the payment terminal 206. The decline reason message may, for example, indicate a reason why the transaction was declined. In addition or alternatively, the decline reason message may prompt the user 202 to take one or more steps that may lead to or facilitate a successful retry of the transaction that was just declined. Specific examples of decline reason messages will be described below.

At block 626, the payment network 110a may transmit the decline reason message to the payment-enabled mobile device 102a via the channel of communications 208 (FIG. 2). This may occur in a number of ways. For example, the payment network computer 502 may push a notification to the payment-enabled mobile device 102a, which may then call in to a facility provided by or through or in association with the payment network computer 502 to receive the decline reason message. Alternatively, for example, the decline reason message may be sent as a text message. Block 628 represents the payment-enabled mobile device 102a receiving the decline reason message. It may be advantageous for the decline reason message, when received by the payment-enabled mobile device 102a, to be provided to the wallet app 312. In some embodiments, the wallet app may receive the decline reason message as a code, which it can translate into suitable corresponding text pre-stored in the wallet app 312 to display to the user 202 via the payment-enabled mobile device 102a. The displaying of the decline reason message to the user 202 by the payment-enabled mobile device 102a is represented by block 630 in FIG. 6.

At block 632, the user 202 may respond to the decline reason message displayed at 630 by taking one or more remedial steps (e.g., as prompted by the decline reason message). The remedial step(s) may lead to or facilitate a successful retry of the transaction.

In one example, it is assumed that the transaction was low value and was not immediately preceded by a user authentication. It is further assumed that the account issuer 112a declined the transaction because a low value transaction counter maintained by the account issuer 112a had reached a limit such that user authentication was required for the next transaction (i.e.,—in this case—the current transaction). In this situation, the authorization response may contain a data element that indicates that a transaction counter limit had been exceeded, and the decline reason message generated by the payment network computer 502 at block 624 (FIG. 6) may (in coded or plain text form) include a prompt that says “Enter wallet PIN and retry”. When the latter message is displayed by the payment-enabled mobile device 102a at block 630, the user 202 may enter the PIN and tap the payment-enabled mobile device 102a again on the payment terminal 206, resulting in a successful (i.e., approved) retry of the transaction.

In a variant of the above example, the decline reason message and payment-enabled mobile device 102a may prompt for another sort of user authentication, such as via fingerprint scan, facial recognition, or another type of biometric user authentication.

In another variant, a transaction may be declined by the account issuer 112a based on a result of a risk management process. Again the decline reason message may prompt for user authentication and retry, perhaps specifically prompting for a relatively strong authentication such as a biometric user authentication. The account issuer 112a may apply the risk management process only to very high value transactions, in some embodiments.

In another variant, the decline reason message/prompt to the user 202 may call for entry of an online PIN rather than a wallet PIN. (Those who are skilled in the art will recognize that the latter type of PIN is verified locally, at the payment-enabled mobile device 102a, whereas the former type of PIN is verified remotely, by the account issuer 112a.)

In another variant, the transaction may be declined because the user made an error while entering the PIN. The decline reason messaging via the payment-enabled mobile device 102a may prompt for re-entry of the PIN and retry.

In another example, it is assumed that the transaction is a debit account transaction and that the account issuer 112a declines the transaction because there are insufficient funds to cover the transaction in the underlying bank deposit account. The authorization response may include a data code that indicates insufficient funds as the reason the transaction was declined, but the payment terminal 206 may be arranged/programmed such that it provides the same message for all declined transactions, say, “transaction declined.” The payment network 112a, however, may generate and transmit to the payment-enabled mobile device 102a—in coded form or “en claire”—a decline reason message that says, “declined for insufficient funds.” This message may then be displayed to the user 202 via the payment-enabled mobile device 102a. As a remedial measure, the user 202 may operate one or more mobile banking apps on the payment-enabled mobile device 102a to transfer additional funds to the underlying bank deposit account. The user 202 may then retry the transaction, and it may be assumed that upon retry the transaction may be approved because—after the transfer—sufficient funds are available in the underlying bank deposit account.

In some situations, it may not be the case that all the steps of the process of FIG. 6 are performed in real time. For example, in some transactions, the authorization response may be submitted to the account issuer overnight in a batch process some hours after the transaction was initiated. Moreover, if the transaction is declined, the payment network 112a may hold the decline reason messaging until mid-morning of the next day, so as not to prompt the user to take remedial action until what is likely to be a more convenient time for the user.

With a process such as that illustrated in FIG. 6, the bare notification of a declined transaction typically given by a payment terminal may be supplemented with additional messaging to the user's payment-enabled mobile device. This may, at least in some circumstances, allow the user to take remedial steps such as a successful user authentication to allow a retry of the transaction to go forward to approval and consummation.

The teachings of this disclosure may be applied in the context of an e-commerce (online shopping) transaction as well as in a transaction at a retail store, as particularly described in connection with FIG. 6.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of at least some steps and/or omitting one or more steps.

As used herein and in the appended claims, the term “payment card system account” includes a credit card account or a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card or a debit card.

As used herein and in the appended claims, the term “payment card system” refers to a system for handling purchase transactions and related transactions. An example of such a system is the one operated by Mastercard International Incorporated, the assignee of the present disclosure. In some embodiments, the term “payment card system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
employing a payment-enabled mobile device to initiate a transaction at a payment terminal, said payment-enabled mobile device in communication with the payment terminal via a first communication channel;
receiving an indication via the payment terminal that the transaction is declined, said indication visually displayed on a display component of the payment terminal; and
displaying a decline reason message on the payment-enabled mobile device, said decline reason message presenting information received by the payment-enabled mobile device via a second communication channel different from the first communication channel.

2. The method of claim 1, wherein the first communication channel is a short-range radio communication channel.

3. The method of claim 2, wherein the second communication channel includes a mobile telecommunication network with which the payment-enabled mobile device is registered.

4. The method of claim 3, wherein the first communication channel is operated according to the NFC (near field communication) protocol.

5. The method of claim 1, wherein the decline reason message is displayed on the payment-enabled mobile device under control by a wallet application that runs on the payment-enabled mobile device.

6. The method of claim 5, wherein said information presented by the decline reason message is received via said wallet application.

7. The method of claim 5, wherein said information presented by the decline reason message is different from said indication.

8. The method of claim 1, wherein the decline reason message prompts a user to engage in a user authentication process via the payment-enabled mobile device.

9. The method of claim 8, wherein the user authentication process includes the user entering a PIN (personal identification number).

10. The method of claim 9, wherein the PIN is a mobile PIN.

11. The method of claim 9, wherein the PIN is an online PIN.

12. The method of claim 8, wherein the user authentication process is a biometric user authentication process.

13. A method comprising:
receiving a transaction authorization response message from an account issuer, the transaction authorization response message related to a requested payment account system transaction, the transaction authorization response message indicating that the requested payment account system transaction is declined; and
transmitting a decline reason message to a wallet application in a payment-enabled mobile device, the decline reason message indicative of at least one reason why the requested payment account system transaction is declined.

14. The method of claim 13, wherein the transmitting step includes transmitting the decline reason message via a first communication channel;
the method further comprising:
routing the transaction authorization response message to a point of sale via a second communication channel, the second communication channel separate from the first communication channel.

15. The method of claim 14, wherein the first communication channel includes a mobile telecommunication network, with which the payment-enabled mobile device is registered.

16. The method of claim 15, wherein the payment-enabled mobile device does not receive the transaction authorization response message.

17. The method of claim 13, wherein said wallet application was employed to request said requested payment account system transaction.

18. An apparatus comprising:
a processor; and
a memory in communication with the processor, the memory storing program instructions, the processor operative with the program instructions to perform functions as follows:
receiving a transaction authorization response message from an account issuer, the transaction authorization response message related to a requested payment account system transaction, the transaction authorization response message indicating that the requested payment account system transaction is declined; and
transmitting a decline reason message to a wallet application in a payment-enabled mobile device, the decline reason message indicative of at least one reason why the requested payment account system transaction is declined.

19. The apparatus of claim 18, wherein:
the transmitting step includes transmitting the decline reason message via a first communication channel; and
the processor is further operative with the program instructions to route the transaction authorization response message to a point of sale via a second communication channel, the second communication channel separate from the first communication channel.

20. The apparatus of claim 19, wherein the first communication channel includes a mobile telecommunication network, with which the payment-enabled mobile device is registered.
